(19) United States
(12) Patent Application Publication
(10) Pub. No.: US 2010/0239936 A1
(43) Pub. Date: Sep. 23, 2010

(54) FUEL CELL SYSTEM AND METHOD OF OPERATING THE SAME

(75) Inventors: Jung-Kurn Park, Suwon-si (KR); Seong-Kee Yoon, Suwon-si (KR); Young-Seung Na, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD., Sunwon-si (KR)

(21) Appl. No.: 12/711,122

(22) Filed: Feb. 23, 2010

(30) Foreign Application Priority Data
Mar. 19, 2009 (KR) 10-2009-0023631

(51) Int. Cl. H01M 8/04

(52) U.S. Cl. 429/447

(57) ABSTRACT

A fuel cell system, which can supply a stable flow rate of fuel to a fuel cell stack is disclosed. The fuel cell system may include a fuel cell stack for generating electricity by an electrochemical reaction of a fuel and an oxidizing agent, a fuel supply unit for supplying a fuel to the fuel cell stack, an oxidizing agent supply unit for supplying an oxidizing agent to the fuel cell stack, and a flow rate controller installed between the fuel cell stack and the fuel supply unit. The fuel cell system may include a feed pump for pressurizing the fuel, a first resistor connected to the front end of the feed pump to reduce flow rate and a second resistor connected to the rear end of the feed pump to reduce flow rate. A method of operating a fuel cell system is also disclosed. The method may include supplying fuel to a fuel cell stack from a fuel supply unit, reducing a flow rate by a first resistor, activating a feed pump, reducing a flow rate by a second resistor, and stopping the feed pump.

### CROSS-REFERENCE TO RELATED APPLICATIONS

This application claims priority to and the benefit of Korean Patent Application No. 10-2009-0023631 filed on Mar. 19, 2009, the entire contents of which are hereby incorporated by reference.

### BACKGROUND

1. Field of the Invention

The following description relates to a fuel cell system and a method of operating the same.

2. Description of the Related Technology

A fuel cell is a device that produces electrical energy electrochemically by using a fuel (hydrogen or reformed gas) and an oxidizing agent (oxygen or air), and is also a device in which the fuel (hydrogen or reformed gas) and the oxidizing agent (oxygen or air) are continuously supplied to thereby convert them directly into electrical energy. Pure oxygen or air enriched with oxygen is used as the oxidizing agent of the fuel cell, and pure hydrogen or a fuel enriched with hydrogen generated from a reformed hydrocarbon fuel (LNG, LPG or CH3OH) is used as the fuel. Such fuel cells can be broadly classified into polymer electrolyte membrane fuel cells (PEMFC), direct oxidation membrane fuel cells and direct methanol fuel cells (DMFC).

The polymer electrolyte membrane fuel cell includes a fuel cell body, also called a stack, which generates electrical energy through an electrochemical reaction of hydrogen gas supplied from a reformer and air supplied through operation of an air pump or fan. The reformer functions as a fuel processor that reforms a fuel to generate hydrogen gas and supplies the hydrogen gas to the stack.

The direct oxidation fuel cell is directly supplied with an alcohol-based fuel, and generates electrical energy from electrochemical reaction of hydrogen, included in the fuel, and air, supplied separately without using hydrogen gas, unlike the polymer electrolyte membrane fuel cell. The direct methanol fuel cell refers to a cell among the direct oxidation fuel cells that uses methanol as a fuel.

For convenience of explanation, the following description will be given of the direct methanol fuel cell among these fuel cells. In a fuel cell system, it is very important to supply a uniform amount of fuel. For example, in a 20 W direct methanol fuel cell system a change of 0.03 cc/min in flow rate generates approximately 10% difference in fuel efficiency. Such a flow rate change causes changes in operating conditions, such as an operation concentration, an operation temperature and an operation pressure, thereby degrading the stability of the fuel cell stack and shortening the life span thereof.

One of the most common methods for the fine control of flow rate is to use a precision flow meter and a high-precision pump. While a precision flow meter for measuring large flow rates is commercially available, a precision flow meter for measuring small flow rates is expensive and has difficulty in measuring correct flow rates because the high-precision flow meter is significantly affected by temperature, pressure and pulsations of the pump.

Moreover, the high-precision pump has difficulty in precisely supplying fuel because it is significantly affected by a change in pressure. Changes in operating pressure occur due to various causes, such as a change in the remaining amount of a fuel cartridge, a change in system operating direction or a change in the moving pressure of a fuel. Accordingly, it is difficult to precisely control a flow rate by using the high-precision pump under the circumstance in which it is difficult to avoid changes in operating pressure.

In addition, in the case of using a low-flow high-precision pump, when piping of a liquid pump fills with gas, it is difficult to perform self-priming for drawing a liquid. This is because the low-flow high-precision pump is designed to operate at a low operating pressure. If a negative pressure is applied due to the gas filled in the piping, fuel supply may be stopped.

Further, there is a problem that the low-flow high-precision pump requires fine control, such as rpm control, frequency control and PWM control, to supply a precise flow rate, the configuration of a circuit for performing such control becomes complex and faults often occur.

Additionally, the low-flow high-precision pump has low durability since it is weak with respect to the introduction of impurities and the performance is severely degraded when used for a long time. Usually, the low-flow high-precision pump is manufactured to be used in a laboratory, but has the problem of low durability, which makes it impossible to be used in a place where fuel with many impurities is supplied for a long time.

Finally, the low-flow high-precision pump is highly expensive, so that it is not practical to apply the pump to a fuel cell.

The above information disclosed in this Background section is only for enhancement of understanding of the background of the invention and therefore it may contain information unknown to a person of ordinary skill in the art.

### SUMMARY OF CERTAIN INVENTIVE ASPECTS

In one aspect, a fuel cell system is configured to supply a stable flow rate of fuel to the stack. In another aspect, is a method of operating a fuel cell system configured to supply a stable fuel flow rate to the stack. In another aspect, a fuel cell system comprises a fuel cell stack configured to generate electricity by an electrochemical reaction of a fuel and an oxidizing agent, a fuel supply unit configured to supply a fuel to the fuel cell stack, an oxidizing agent supply unit configured to supply an oxidizing agent to the fuel cell stack and a flow rate controller installed between the fuel cell stack and the fuel supply unit, the flow rate controller comprising a feed pump for pressurizing the fuel, a first resistor in fluid communication with a front end of the feed pump and configured to reduce flow rate, and a second resistor in fluid communication with a rear end of the feed pump and configured to reduce flow rate.

In some embodiments, a smallest cross-sectional area of the first resistor is smaller than a cross-sectional area of a pipe installed on the side of the first resistor. In some embodiments, the smallest cross-sectional area of the second resistor is smaller than the cross-sectional area of a pipe installed on the side of the second resistor. In some embodiments, the first resistor comprises a check valve. In some embodiments, the first resistor is one of a nozzle and a valve. In some embodiments, the second resistor comprises a check valve. In some embodiments, the second resistor is one of a nozzle and a valve. In some embodiments, the feed pump has a rated flow rate that is about 100 to about 800 times higher than a flow rate of the fuel supplied to the fuel cell stack. In some embodiments, the fuel cell system comprises a direct methanol type fuel cell system. In some embodiments, when the maximum pressure of the feed pump is Pₘₐₓ, the maximum flow rate by the feed pump is Rₘₐₓ, the flow rate to be reduced by the first check valve and the second check valve is R₁, and the sum of resistance pressures generated in the first check valve and second check valve is P₀, then P₀=(Rₘₐₓ−R₁)×Pₘₐₓ/Rₘₐₓ. In some embodiments, the fuel cell system further comprises a buffer between the second resistor and the fuel cell stack.

In another aspect, a method of operating a fuel cell system comprises supplying fuel to a fuel cell stack from a fuel supply unit, reducing the fuel flow rate by a first resistor, activating a feed pump, reducing the fuel flow rate by a second resistor and stopping the feed pump.

In some embodiments, when the fuel flow rate after being reduced by the first resistor and the second resistor is R₁, an operating time during which the feed pump operates is t₁, a stopping time during which the operation of the feed pump is stopped is t₂, and a target flow rate supplied to the fuel cell stack is R₂, then R₂=(R₁×t₁)/(t₁+t₂). In some embodiments, the method further comprises repeatedly activating and stopping the feed pump. In some embodiments, the first resistor is one of a check valve, a nozzle and a valve. In some embodiments, the second resistor is one of a check valve, a nozzle and a valve. In some embodiments, the feed pump is a pump having a fuel flow rate that is about 100 to about 800 times higher than the fuel flow rate of the fuel supplied to the fuel cell stack. In some embodiments, the method further comprises distributing the fuel flow using a buffer installed between the second resistor and the fuel cell stack.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus according to some of the described embodiments can have several aspects, no single one of which necessarily is solely responsible for the desirable attributes of the apparatus. After considering this discussion, and particularly after reading the section entitled “Detailed Description of Certain Inventive Embodiments” one will understand how illustrated features serve to explain certain principles of the present disclosure.

FIG. 1 is a configuration diagram schematically showing a fuel cell system according to a first exemplary embodiment.

FIG. 2 is an exploded perspective view showing a structure of the fuel cell stack shown in FIG. 1.

FIG. 3 is a configuration diagram showing a flow rate controller of a fuel cell system according to a second exemplary embodiment.

FIG. 4 is a configuration diagram showing a flow rate controller of a fuel cell system according to a third exemplary embodiment.

FIG. 5 is a configuration diagram showing a flow rate controller of a fuel cell system according to a fourth exemplary embodiment.

FIG. 6 is a graph showing the flow rate of fuel introduced into the fuel cell stack of the fuel cell system according to the first exemplary embodiment.

FIG. 7 is a graph showing the flow rate of fuel introduced into the fuel cell stack according to a change in water head in the fuel cell system according to the first exemplary embodiment.

FIG. 8A is a graph showing output and voltage of the fuel cell system according to the first exemplary embodiment.

FIG. 8B is a graph showing a fuel concentration and cell deviation of the fuel cell system according to the first exemplary embodiment.

FIG. 8C is a graph showing an anode outlet temperature of the fuel cell stack according to the first exemplary embodiment.

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements. Hereinafter, certain embodiments will be described in more detail with reference to the accompanying drawings, so that a person having ordinary skill in the art can readily make and use aspects of the present disclosure.

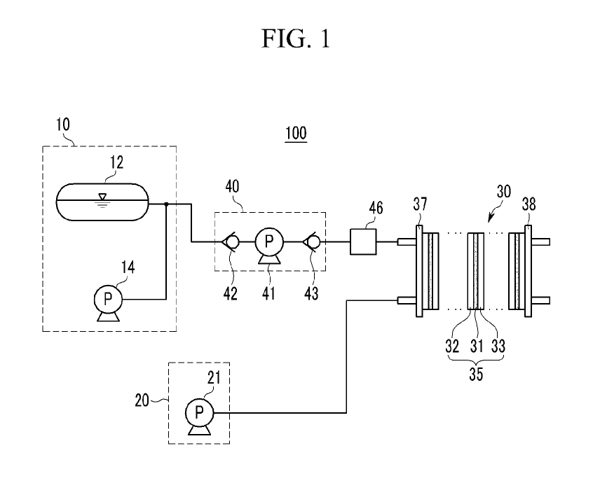

FIG. 1 is a configuration diagram schematically illustrating a fuel cell system according to a first exemplary embodiment. The fuel cell system 100 can employ a direct methanol fuel cell that generates electrical energy by a direct reaction of methanol and oxygen. However, the present disclosure is not limited thereto, and the fuel cell system 100 can be formed as a direct oxidation fuel cell for bringing a liquid or gaseous fuel containing hydrogen, such as ethanol, LPG, LNG, gasoline or butane gas, into reaction with oxygen. In addition, the fuel cell system 100 may be formed as a polymer electrode membrane fuel cell (PEMFC) in which a fuel is reformed to a gas enriched with hydrogen for use. Such fuels used in the fuel cell system 100 are commonly hydrocarbon-based fuels in liquid or gaseous form, such as methanol, ethanol, natural gas, LPG, etc. Also, the present fuel cell system 100 can use oxygen gas stored in a separate storage means or air as an oxidizing agent to be reactive with hydrogen.

The fuel cell system 100 includes a fuel cell stack 30 configured to generate electricity by using a fuel and an oxidizing agent, a fuel supply unit 10 configured to supply a fuel to the fuel cell stack 30, an oxidizing agent supply unit 20 configured to supply an oxidizing agent for electricity generation to the fuel cell stack 30 and a flow rate controller 40 installed between the fuel cell stack 30 and the fuel supply unit 10.

The fuel supply unit 10 is for supplying a fuel to the fuel cell stack 30, and includes a fuel tank 12 that stores liquid fuel and a fuel pump 14 that is connected to the fuel tank 12. The fuel pump 14 may function to discharge the liquid fuel stored in the fuel tank 12 from the fuel tank 12 with a predetermined pumping power. The fuel stored in the fuel supply unit 10 may be methanol.

The oxidizing agent supply unit 20 is connected to the fuel cell stack 30, and includes an oxidizing pump 21 configured to inhale outside air with a predetermined pumping power and supply the air to the fuel cell stack 30.

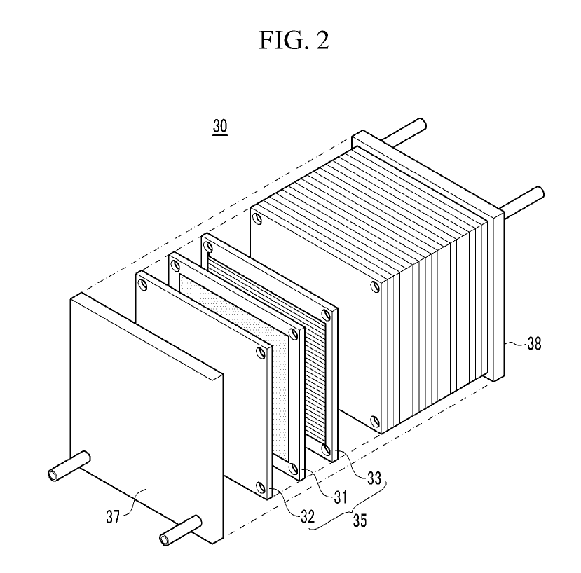

FIG. 2 is an exploded perspective view showing a structure of the fuel cell stack shown in FIG. 1. Referring to FIG. 1 and FIG. 2, the fuel cell stack 30 will be discussed in detail. The present fuel cell stack 30 includes a plurality of electricity generators 35 configured for generating electrical energy by inducing an oxidation/reduction reaction of a fuel and an oxidizing agent. Each of the electricity generators 35 is a unit cell configured to generate electrical energy. Each of the electricity generators 35 may include a membrane electrode assembly (MEA) 31 performing the oxidation and reduction between the fuel and the oxygen in the oxidizing agent and separators 32 and 33 (also referred to as bipolar plates in the art) configured to supply the fuel and the oxidizing agent to the membrane electrode assembly 31.

In each of the electricity generators 35, the separators 32 and 33 may be disposed at respective sides of the membrane electrode assembly 31 with the membrane electrode assembly 31 interposed therebetween. The membrane electrode assembly 31 may include an electrolyte membrane disposed at the center, a cathode disposed on one side of the electrolyte membrane and an anode disposed on the other side of the electrolyte membrane.

In some embodiments the separators 32 and 33 are disposed close to each other with the membrane electrode assembly 31 interposed therebetween, thereby forming a fuel path and an air path at respective sides of the membrane electrode assembly 31. The fuel path is disposed on the anode side of the membrane electrode assembly 31 and the air path is disposed on the cathode side of the membrane electrode assembly 31. Further, the electrolyte membrane is configured to enable ion exchange in which the hydrogen ions generated in the anode are moved to the cathode and combine with the oxygen in the cathode to thus generate water.

In the anode, the hydrogen is decomposed into electrons and protons (hydrogen ions) through an oxidation reaction. The protons flow to the cathode through the electrolyte membrane, while the electrons that are unable to flow through the electrolyte membrane flow instead to the cathode of the adjacent membrane electrode assembly 31 through the separator 33. The flow of the electrons forms a current. In the cathode, moisture is generated through a reduction reaction of oxygen with the transferred protons and electrons.

In the fuel cell system 100, the fuel cell stack 30 is configured by consecutively disposing the plurality of electricity generators 35 as described above. Herein, end plates 37 and 38 for integrally fastening the fuel cell stack 30 are installed on the outermost sides of the fuel cell stack 30.

A description will be made of an example in which the fuel cell stack 30 is a 20 W fuel cell stack 30, which is of a small capacity. The present disclosure, however, is not limited to this example.

The flow rate controller 40 installed between the fuel cell stack 30 and the fuel supply unit 10 includes a feed pump 41, a first check valve 42 and a second check valve 43. The feed pump 41 may be a high flow pump. If a target flow rate to be supplied to the fuel cell stack 30 is about 0.4 cc/min, the feed pump 41 may be a pump having a rated flow of about 100 cc/min. More specifically, the feed pump 41 may have a flow rate that is about 100 to about 800 times higher than the target flow rate. If the feed pump 41 is a high flow pump as described above, a change in operating pressure within a 10 kPa range has no significant effect on the feed pump 41 since the feed pump 41 operates over a range of several tens of kPa. Accordingly, fuel can be stably supplied even if the water head changes, and self-priming is possible because the operating pressure is high. Also, the high flow pump has a low failure rate due to its flow rate, and hence, the durability of the system may be improved and manufacturing costs can be reduced.

In addition, the feed pump 41 may be a low-precision pump. Even if the feed pump 41 is a low-precision pump, the first check valve 42 and the second check valve 43 decrease the flow rate of the feed pump 41, thereby attaining sufficient precision of flow rates. That is, if it is assumed that the feed pump 41 having a flow rate of about 100 cc/min has a flow rate error of about 3%, it can be found that when the flow rate is reduced to about 0.4 cc/min, which is about 4/1000 of the flow rate of about 100 cc/min, the actual flow rate error is about 0.0012 cc/min, which is very small. While it is easy to set an error of about 3% in a pump having a large flow rate, it is very difficult to control an error in a pump having a small flow rate to about 3%.

The first check valve 42 is installed between the feed pump 41 and the fuel supply unit 10. The first check valve 42 serves as a first resistor configured to reduce the fuel flow rate. In this disclosure, a resistor means a device that increases pressure at the front of the resistor and decreases the flow rate passing through the resistor by reducing a cross-sectional area of a flow path.

The smallest cross-sectional area through which fuel flows in the first check valve 42 is smaller than the cross-sectional area of a pipe installed at the inlet of the first check valve 42. As a consequence, a resistance pressure is generated while fuel passes through the first check valve 42, so that the first check valve 42 is firstly able to reduce the flow rate and dampen a change of the pressure transferred from the fuel supply unit 10. Changes in pressure are transferred to the feed pump 41 according to a change in water head depending on the height of the fuel tank 12, a change in pressure depending on the pulsation of the fuel pump 14, and so forth. The first check valve 42 dampens such changes.

The second check valve 43 is installed between the feed pump 41 and the fuel cell stack 30. The second check valve 43 serves as a second resistor configured to reduce the fuel flow rate. The smallest cross-sectional area through which fuel flows in the second check valve 43 is smaller than the cross-sectional area of a pipe installed at the inlet of the second check valve 43. Accordingly, the second check valve 43 can reduce the flow rate of fuel from the feed pump 41 and reduce a pulsation pressure generated in the feed pump 41.

By reducing flow rates by means of the first check valve 42 and the second check valve 42 as described above, a small amount of fuel can be supplied more precisely to the fuel cell stack 30. Moreover, backflow of fuel can be prevented by applying check valves, and flow rates can be adjusted by setting an appropriate resistance.

When applying the feed pump 41 having a flow rate of about 100 cc/min, if the flow rate in the first check valve 42 is reduced by about ½ and the flow rate in the second check valve 43 is reduced by about ⅕, the flow rate passing through the second check valve 43 can be reduced to about 10 cc/min. In this state, when the operating time is set to 1 second and the non-operating time is set to 24 seconds by controlling the operation of the feed pump 41, about 0.4 cc/min of fuel can be supplied to the fuel cell stack 30.

Assuming that the maximum pressure of the feed pump 41 is Pₘₐₓ, the maximum flow rate by the feed pump 41 is Rₘₐₓ and the flow rate to be reduced by the first check valve 42 and the second check valve 43 is R₁, the sum P₀ of resistance pressures generated in the first check valve 42 and second check valve 43 may be expressed by the following Formula 1.

P₀=(Rₘₐₓ−R₁)×Pₘₐₓ/Rₘₐₓ Formula 1

Through the above Formula 1, resistance pressures to be generated by the first check valve 42 and the second check valve 43 may be easily set.

In a case where a large capacity pump is applied without installing the check valves 42 and 43, the operating time of the pump may be too short and the flow rate supplied during the short period of time may be too high, thereby lowering the fuel efficiency. Further, the lifespan of the fuel cell stack may deteriorate due to an ejection pressure of the fuel.

Additionally, the flow rate may be reduced to a certain extent even in a case where one check valve is installed. However, the flow rate discharged from the pump is too high and hence the operating time of the pump is excessively shortened. Consequently, the fuel efficiency may deteriorate, and too much pressure may be applied to the fuel cell stack.

However, as in the present exemplary embodiment, if the flow rate is decreased in two stages by means of two check valves 42 and 43, an appropriate amount of fuel can be supplied to the fuel cell stack 30 by regulating the operating time.

The flow rate controller 40 may further include a buffer 46 installed between the second check valve 43 and the fuel cell stack 30. The buffer 46 may function to dampen a change in flow rate generated between operating time and stop time. The fuel temporarily stored in the buffer 46 is gradually supplied to the fuel cell stack 30 by a pressing force of the feed pump 41.

An operating method of the fuel cell system 100 according to the present exemplary embodiment will be described below.

The operating method of the fuel cell system 10 may include, for example, reducing a flow rate to a first resistor, activating operation of a feed pump 41, reducing the flow rate to a second resistor and stopping the operation of the feed pump 41. Here, the first resistor includes a first check valve 42, and the second resistor includes a second check valve 43. However, the present disclosure is not limited thereto, and the first resistor and the second resistor may include, for example, a nozzle or a valve similar to those described below.

Assuming that the flow rate flowing to the first resistor and the second resistor after being reduced is R₁, an activation time for operating the feed pump 41 is t₁, a stop time for stopping the operation of the feed pump 41 is t₂, and a target flow rate supplied to the fuel cell stack 30 is R₂, the relationship between t₁ and t₂ can be expressed by the following Formula 2.

R₂=(R₁×t₁)/(t₁±t₂) Formula 2

If an operating time and a stopping time are set in this manner, an appropriate amount of fuel can be supplied to the fuel cell stack 30 by repeatedly performing activating and stopping the operation of the feed pump. The fuel ejected during the operating time is slowly supplied to the fuel cell stack 30. This is because the fuel in the fuel cell stack 30 is not rapidly discharged but moves at a constant speed through a small flow path. Accordingly, additionally supplied fuel stands by in the pipe, and then is slowly introduced into the fuel cell stack 30 during the stopping time.

In addition, the operating method of the fuel cell system 100 may further include distributing the flow of the fuel supplied to the fuel cell stack 30 by using the buffer 46. In this step, the fuel is temporarily stored in the buffer 46 and is then slowly supplied to the fuel cell stack 30 during the stopping time. Through this step, the pressure applied to the fuel cell stack 30 by the feed pump 41 can be alleviated and the fuel can be supplied more uniformly to the entire fuel cell stack 30.

FIG. 3 is a configuration diagram showing a flow rate controller of a fuel cell system according to a second exemplary embodiment.

A flow rate controller 50 includes a feed pump 51 installed between a fuel supply unit 10 and a fuel cell stack 30, a first nozzle 52 and a second nozzle 53. The first nozzle 52 is installed between the feed pump 51 and the fuel supply unit 10, and serves as a first resistor that reduces the flow rate of fuel. With a change in water head depending on the height of a fuel tank 12, a pressure change depending on the pulsation of the fuel pump 14, and so forth, a change in pressure is transferred to the feed pump 51. The first nozzle 52 dampens such a change. Also, the first nozzle reduces the amount of fuel introduced into the feed pump 51 by firstly reducing the flow rate. The second nozzle 53 is installed between the feed pump 51 and the fuel cell stack 30, and serves as a second resistor that reduces the flow rate of fuel. If the outlets of the nozzles 52 and 53 are set to be smaller, the flow velocity in the nozzles 52 and 53 becomes higher, but the pressure in front of the nozzles 52 and 53 increases and the flow rate passing through the nozzles 52 and 53 decreases.

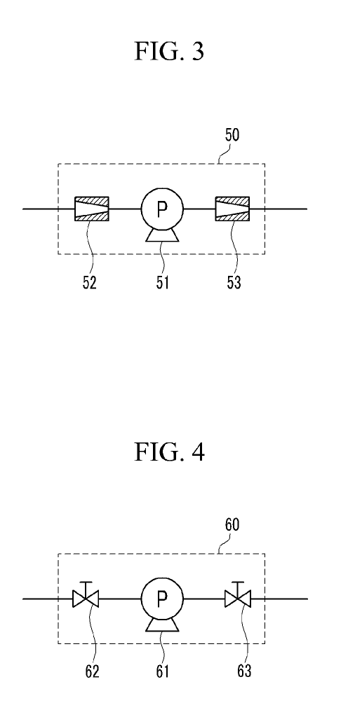

FIG. 4 is a configuration diagram showing a flow rate controller of a fuel cell system according to a third exemplary embodiment. A flow rate controller 60 includes a feed pump 61 installed between a fuel supply unit 10 and a fuel cell stack 30, a first valve 62, and a second valve 63. The first valve 62 is installed between the feed pump 61 and the fuel supply unit 10, and serves as a first resistor that reduces the flow rate of fuel. The second valve 63 is installed between the feed pump 61 and the fuel cell stack 30, and serves as a second resistor that reduces the flow rate of fuel. By adjusting the first valve 62 and the second valve 63, the flow rate of fluid passing through the valves can be easily set. A cross-sectional area of the flow path in the first valve 62 and the second valve 63 is smaller than a cross-sectional area of the pipe installed on the side to which fuel is introduced. Accordingly, the pressure in front of the first valve 62 and the second valve 63 increases and the total flow rate decreases.

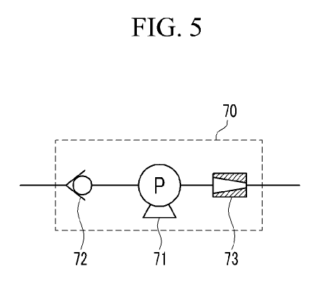

FIG. 5 is a configuration diagram showing a flow rate controller of a fuel cell system according to a fourth exemplary embodiment. A flow rate controller 70 includes a feed pump 71 installed between a fuel supply unit 10 and a fuel cell stack 30, a check valve 72 installed at the front end of the feed pump 71 and a nozzle 73 installed at the rear end of the feed pump 71. The check valve 72 is installed between the feed pump 71 and the fuel supply unit 10, and the nozzle 73 is installed between the feed pump 71 and the fuel cell stack 30. The check valve 72 and the nozzle 73 serve as respective resistors that reduce the flow rate of fuel. The check valve 72 can control the flow rate by adjusting the cross-sectional area of the path through which fuel passes and the nozzle 73 can control the flow rate by forming a small cross-sectional area of the outlet. Therefore, a resistance pressure is generated in the check valve 72 and the nozzle 73 and the flow rate passing through the check valve 72 and the nozzle 73 diminishes.

Although the present exemplary embodiment illustrates a case in which the check valve 72 is installed at the front end of the feed pump 71 and the nozzle 73 is installed at the rear end thereof, the present disclosure is not limited thereto. Accordingly, the nozzle 73 may be installed at the front end of the feed pump 71, and the check valve 72 may be installed at the rear end thereof. Also, the check valve and a typical valve may be applicable together as a resistor, and the nozzle and a typical valve may be applicable together as a resistor.

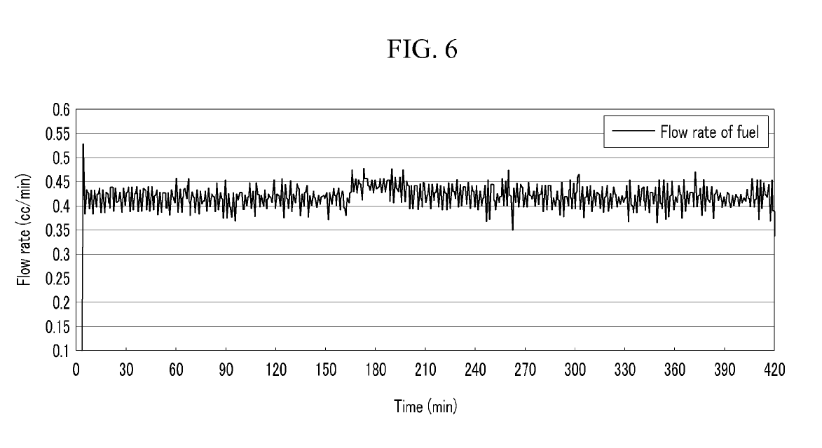

FIG. 6 is a graph showing the flow rate of fuel introduced into the fuel cell stack of the fuel cell system according to the first exemplary embodiment. The fuel cell system used in this measurement has a capacity of 40 W, and its target fuel flow rate is about 0.4 cc/min. Referring to FIG. 6, it can be seen that, although there are certain deviations, a nearly uniform amount of fuel is introduced into the fuel cell stack 30. In this manner, flow rates can be controlled with high precision even if a high flow feed pump is applied.

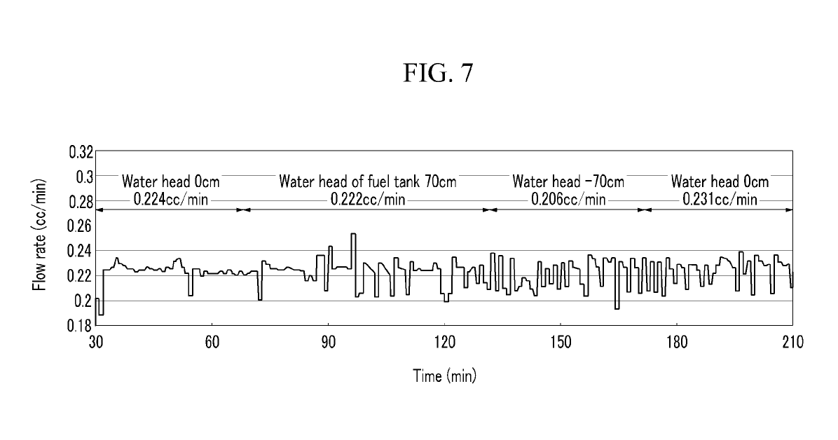

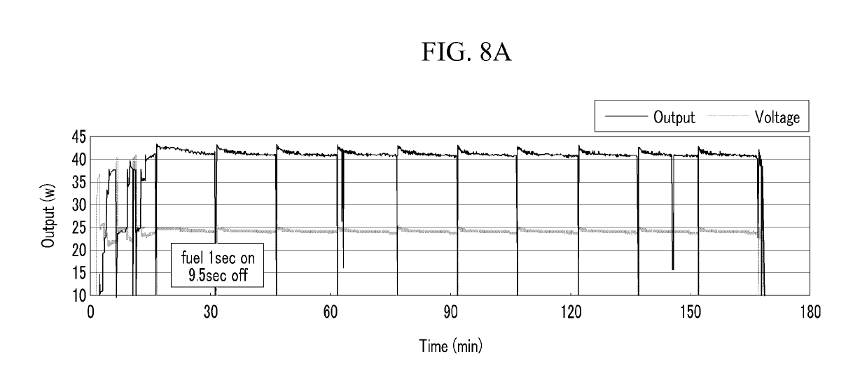

FIG. 7 is a graph showing the flow rate of fuel introduced into the fuel cell stack according to a change in water head in the fuel cell system according to the first exemplary embodiment. The fuel cell system used in this measurement has a capacity of about 40 W, and its target fuel flow rate is about 0.22 cc/min. As a result of testing the flow rate by comparison when the water head of the fuel tank is about 0 cm, about 70 cm, and about −70 cm, respectively, it can be seen that, as shown in FIG. 7, the fuel is supplied to the fuel cell stack 30 without much variation in the flow rate.

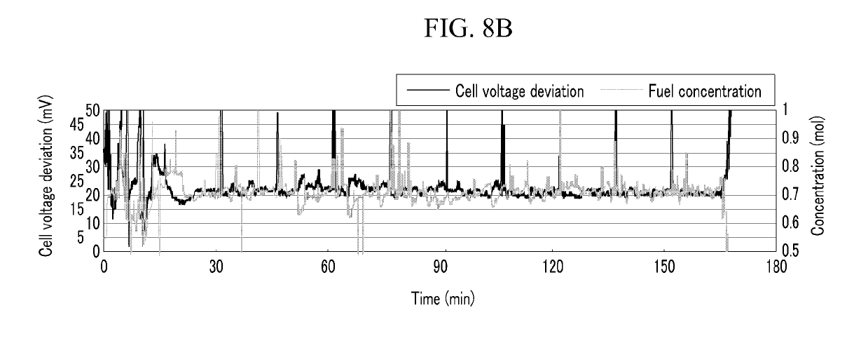

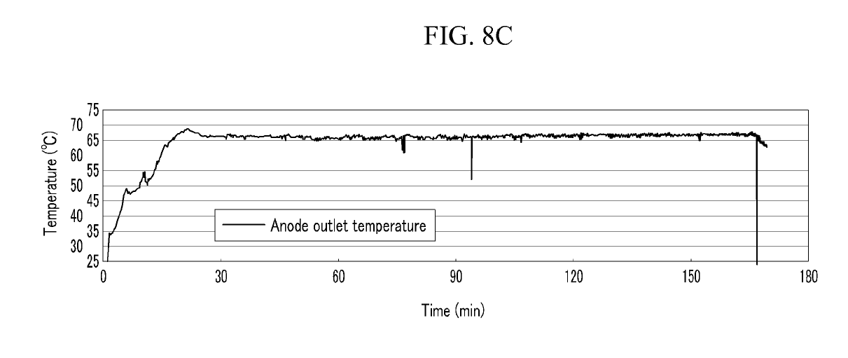

FIG. 8A is a graph showing an output and voltage of the fuel cell system according to the first exemplary embodiment. FIG. 8B is a graph showing a fuel concentration and cell deviation of the fuel cell system according to the first exemplary embodiment. FIG. 8C is a graph showing an anode outlet temperature of the fuel cell stack according to the first exemplary embodiment.

The fuel cell system used in this measurement has a capacity of about 40 W, and its target fuel flow rate is about 0.4 cc/min. The operating time of the feed pump is about 1 second and the stopping time thereof is about 9.5 seconds.

As shown in FIG. 8A, it can be seen that the voltage and output are unstable at an initial stage of fuel supply but the voltage and output are almost constant after stabilization. The voltage and output are periodically decreased because the supply of air and fuel is adjusted for recovering.

Meanwhile, as shown in FIG. 8B, the cell voltage deviation is also kept almost constant, and the concentration of the fuel is also kept almost constant in spite of a change in water head. A change in operating pressure depending on a change in water head is ±5 kPa, and in spite of such a change in operating pressure, the concentration of the fuel is kept very stable at 0.705±0.038 mol. The cell deviation and concentration change periodically increase because of the aforementioned process for recovering.

Meanwhile, as shown in FIG. 8C, when measuring the temperature of unreacted fuel discharged from the anode outlet, the temperature is seen to be kept constant at almost 60° C.

As described above, as a result of evaluating the performance of the fuel cell system according to the first exemplary embodiment, excellent stability can be achieved overall.

It will be appreciated by those skilled in the art that various modifications and changes may be made without departing from the scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Further, while the present disclosure has described certain exemplary embodiments, it is to be understood that the scope of the disclosure is not limited to the disclosed embodiments, but, on the contrary, is intended to cover various modifications and equivalent arrangements included within the spirit and scope of the appended claims and equivalents thereof.

What is claimed is:

1. A fuel cell system, comprising:
a fuel cell stack configured to generate electricity by an electrochemical reaction of a fuel and an oxidizing agent;
a fuel supply unit configured to supply a fuel to the fuel cell stack;
an oxidizing agent supply unit configured to supply an oxidizing agent to the fuel cell stack; and
a flow rate controller installed between the fuel cell stack and the fuel supply unit, the flow rate controller comprising a feed pump for pressurizing the fuel, a first resistor in fluid communication with a front end of the feed pump and configured to reduce flow rate, and a second resistor in fluid communication with a rear end of the feed pump and configured to reduce flow rate.

2. The fuel cell system of claim 1, wherein a smallest cross-sectional area of the first resistor is smaller than a cross-sectional area of a pipe installed on the side of the first resistor.

3. The fuel cell system of claim 1, wherein a smallest cross-sectional area of the second resistor is smaller than the cross-sectional area of a pipe installed on the side of the second resistor.

4. The fuel cell system of claim 1, wherein the first resistor comprises a check valve.

5. The fuel cell system of claim 1, wherein the first resistor is one of a nozzle and a valve.

6. The fuel cell system of claim 1, wherein the second resistor comprises a check valve.

7. The fuel cell system of claim 1, wherein the second resistor is one of a nozzle and a valve.

8. The fuel cell system of claim 1, wherein the feed pump has a rated flow rate that is about 100 to about 800 times higher than a flow rate of the fuel supplied to the fuel cell stack.

9. The fuel cell system of claim 1, wherein the fuel cell system comprises a direct methanol type fuel cell system.

10. The fuel cell system of claim 1, wherein, when the maximum pressure of the feed pump is Pₘₐₓ, the maximum flow rate by the feed pump is Rₘₐₓ, the flow rate to be reduced by the first check valve and the second check valve is R₁, and the sum of resistance pressures generated in the first check valve and second check valve is P₀, then
P₀=(Rₘₐₓ−R₁)×Pₘₐₓ/R_{max.}

11. The fuel cell system of claim 1 further comprising a buffer between the second resistor and the fuel cell stack.

12. A method of operating a fuel cell system, comprising:
supplying fuel to a fuel cell stack from a fuel supply unit;
reducing a fuel flow rate by a first resistor;
activating a feed pump;
reducing a fuel flow rate by a second resistor; and
stopping the feed pump.

13. The method of claim 12, wherein, when the fuel flow rate after being reduced by the first resistor and the second resistor is R₁, an operating time during which the feed pump operates is t₁, a stopping time during which the operation of the feed pump is stopped is t₂, and a target flow rate supplied to the fuel cell stack is R₂, then
R₂=(R₁×t₁)/(t₁+t₂).

14. The method of claim 12 further comprising repeatedly activating and stopping the feed pump.

15. The method of claim 12, wherein the first resistor is one of a check valve, a nozzle and a valve.

16. The method of claim 12, wherein the second resistor is one of a check valve, a nozzle and a valve.

17. The method of claim 12, wherein the feed pump is a pump having a fuel flow rate that is about 100 to about 800 times higher than the fuel flow rate of the fuel supplied to the fuel cell stack.

18. The method of claim 12 further comprising distributing the fuel flow using a buffer installed between the second resistor and the fuel cell stack.
